(19) United States
(12) Patent Application Publication
(10) Pub. No.: US 2024/0361662 A1
(43) Pub. Date: Oct. 31, 2024

(54) OPTICAL MODULATOR

(71) Applicant: Murata Manufacturing Co., Ltd., Nagaokakyo-shi (JP)

(72) Inventors: Satoki HAMAMURA, Nagaokakyo-shi (JP); Yasuhiro AIDA, Nagaokakyo-shi (JP)

(21) Appl. No.: 18/765,419

(22) Filed: Jul. 8, 2024

Related U.S. Application Data
(63) Continuation of application No. PCT/JP2022/043688, filed on Nov. 28, 2022.

(30) Foreign Application Priority Data
Mar. 17, 2022 (JP) 2022-042072

(51) Int. Cl. G02F 1/225; G02F 1/21

(52) U.S. Cl. CPC G02F 1/225; G02F 1/212; G02F 2202/20

(57) ABSTRACT

An optical modulator includes an optical waveguide, a first electrode, two second electrodes, and a third electrode that generates a potential difference from the first electrode and the second electrodes. Each second electrode receives a voltage with an identical phase to a voltage applied to the first electrode. In a cross-sectional view perpendicular to a direction in which the optical waveguide extends, the first electrode is on a first side of the optical waveguide in a thickness direction, one second electrode is spaced apart from the first electrode on a first side of the first electrode in a width direction of the optical waveguide, the other second electrode is spaced apart from the first electrode on a second side of the first electrode in the width direction of the optical waveguide, and the third electrode is on a second side of the optical waveguide in the thickness direction.

### CROSS REFERENCE TO RELATED APPLICATIONS

This application claims the benefit of priority to Japanese Patent Application No. 2022-042072 filed on Mar. 17, 2022 and is a Continuation Application of PCT Application No. PCT/JP2022/043688 filed on Nov. 28, 2022. The entire contents of each application are hereby incorporated herein by reference.

### BACKGROUND OF THE INVENTION

### 1. Field of the Invention

The present invention relates to optical modulators.

### 2. Description of the Related Art

The proliferation of mobile terminals and cloud computing has led to a significant increase in communication traffic over the Internet. This increase expands the demand for optical communications. The optical communication involves an optical transceiver to convert optical signals and electric signals between each other. The optical transceiver includes an optical modulator as a main component. The optical modulator converts electric signals to optical signals.

For example, Japanese Unexamined Patent Application Publication No. 2008-250081 discloses an existing optical modulator. The optical modulator disclosed in Japanese Unexamined Patent Application Publication No. 2008-250081 includes a thin plate with an electrooptic effect, an optical waveguide provided at the thin plate, and control electrodes to control light that passes through the optical waveguide. The control electrodes include a first electrode and a second electrode. The first electrode and the second electrode are arranged to hold the thin plate therebetween. The first electrode includes coplanar electrodes including at least a first signal electrode and a ground electrode. The second electrode includes at least a second signal electrode. The first signal electrode and the second signal electrode receive modulation signals with the phases reversed from each other, and cooperate to apply an electric field to the optical waveguide.

### SUMMARY OF THE INVENTION

In the optical modulator disclosed in Japanese Unexamined Patent Application Publication No. 2008-250081, undeniably, the electric field from the first signal electrode partially leaks to the left and right ground electrodes without passing through the optical waveguide. In addition, undeniably, the electric field from the second signal electrode partially leaks to the left and right ground electrodes without passing through the optical waveguide. The ratio of the electric fields applied to the optical waveguide is thus not high.

Example embodiments of the present invention provide optical modulators each capable of improving a ratio of the electric fields applied to an optical waveguide.

An optical modulator according to an example embodiment of the present disclosure includes an optical waveguide including a material with an electrooptic effect, and control electrodes to control light that passes through the optical waveguide. The control electrodes include a first electrode, two second electrodes, and a third electrode to generate a potential difference from a group of the first electrode and the second electrodes. The second electrodes receive a voltage with an identical phase to a voltage applied to the first electrode. In a cross-sectional view perpendicular to a direction in which the optical waveguide extends, the first electrode is on a first side of the optical waveguide in a thickness direction. In the cross-sectional view, a first one of the two second electrodes is spaced apart from the first electrode on a first side of the first electrode in a width direction of the optical waveguide, and a second one of the two second electrodes is spaced apart from the first electrode on a second side of the first electrode in the width direction of the optical waveguide. In the cross-sectional view, the third electrode is on a second side of the optical waveguide in the thickness direction.

Optical modulators according to example embodiments of the present disclosure improve the ratio of the electric fields applied to the optical waveguide.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic cross-sectional view of an optical modulator according to a first example embodiment of the present invention.

FIG. 2 is a schematic cross-sectional view of an optical modulator according to a first modification example.

FIG. 3 is a schematic cross-sectional view of the optical modulator according to the first modification example.

FIG. 4 is a schematic cross-sectional view of the optical modulator according to the first modification example.

FIG. 5 is a schematic cross-sectional view of an optical modulator according to a second example embodiment of the present invention.

FIG. 6 is a schematic cross-sectional view of an optical modulator according to a third example embodiment of the present invention.

FIG. 7 is a schematic cross-sectional view of an optical modulator according to a second modification example.

FIG. 8 is a schematic cross-sectional view of an optical modulator according to a second modification example.

FIG. 9 is a schematic cross-sectional view of an optical modulator according to a second modification example.

FIG. 10 is a schematic cross-sectional view of an optical modulator according to a third modification example.

FIG. 11 is a schematic cross-sectional view of an optical modulator according to a third modification example.

FIG. 12 is a schematic cross-sectional view of an optical modulator according to a third modification example.

FIG. 13 is a schematic cross-sectional view of an optical modulator according to a third modification example.

FIG. 14 is a schematic cross-sectional view of an optical modulator according to a third modification example.

FIG. 15 is a schematic cross-sectional view of an optical modulator according to a fourth example embodiment of the present invention.

FIG. 16 is a schematic cross-sectional view of an optical modulator according to a fifth example embodiment of the present invention.

FIG. 17 is a schematic cross-sectional view of an optical modulator according to a sixth example embodiment of the present invention.

FIG. 18 is a schematic cross-sectional view of an optical modulator according to a seventh example embodiment of the present invention.

FIG. 19 is a schematic plan view of an optical modulator according to the seventh example embodiment of the present invention.

FIG. 20 is a schematic cross-sectional view of an optical modulator according to an eighth example embodiment of the present invention.

FIG. 21 is a schematic plan view of the optical modulator according to the eighth example embodiment of the present invention.

### DETAILED DESCRIPTION OF THE EXAMPLE EMBODIMENTS

Example embodiments of the present disclosure are described below. Although the example embodiments of the present disclosure are described in the following description, the present disclosure is not limited to the examples described below. Although specific numerical values or specific materials may be described below, the present disclosure is not limited to these examples.

An optical modulator according to the present example embodiment includes an optical waveguide including a material with an electrooptic effect, and control electrodes to control light that passes through the optical waveguide. The control electrodes include a first electrode, two second electrodes, and a third electrode to generate a potential difference from a group of the first electrode and the second electrodes. The second electrodes receive a voltage with an identical phase to a voltage applied to the first electrode. In a cross-sectional view perpendicular to a direction in which the optical waveguide extends, the first electrode is on a first side of the optical waveguide in a thickness direction. In the cross-sectional view, a first one of the two second electrodes is spaced apart from the first electrode on a first side of the first electrode in a width direction of the optical waveguide, and a second one of the two second electrodes is spaced apart from the first electrode on a second side of the first electrode in the width direction of the optical waveguide. In the cross-sectional view, the third electrode is on a second side of the optical waveguide in the thickness direction (first structure).

In the optical modulator in the first structure, the first electrode and the third electrode are arranged to hold the optical waveguide therebetween in the thickness direction. In addition, the two second electrodes are arranged adjacent to the first electrode and spaced apart from the first electrode, to hold the first electrode in the width direction of the optical waveguide. During an operation of the optical modulator, the first electrode and the two second electrodes receive the voltage of the same phase. Electric fields thus individually operate from the first electrode and the second electrodes toward the third electrode to be applied to the optical waveguide. In this case, unlike in Japanese Unexamined Patent Application Publication No. 2008-250081 including a single signal electrode on a first side of the optical waveguide in the thickness direction and only the electric field from this signal terminal is applied to the optical waveguide, the electric fields directed from the two second electrodes are applied to the optical waveguide in addition to the electric field from the first electrode. The ratio of the electric fields applied to the optical waveguide can thus be improved. Herein, such a ratio of the electric fields applied to the optical waveguide may be referred to as efficiency of electric-field application to the optical waveguide.

The optical modulator in the first structure preferably includes the following structure. In a cross-sectional view perpendicular to the direction in which the optical waveguide extends, a middle position of the first electrode in the width direction is at the middle portion of the optical waveguide in the width direction, and the middle position of the third electrode in the width direction is at the middle portion of the optical waveguide in the width direction (second structure). In this case, the intensity of the electric field oriented from the first electrode to the third electrode can be enhanced, and the efficiency of electric-field application to the optical waveguide can be enhanced.

The above optical modulator preferably has the following structure. In a cross-sectional view perpendicular to the direction in which the optical waveguide extends, the two second electrodes are arranged in the width direction of the optical waveguide symmetrically with respect to the first electrode (third structure). In this case, the disparity in effective refractive index can be reduced and the optical loss can be reduced.

Preferably, the optical modulator includes the following structure. In the width direction of the optical waveguide, the first one of the second electrodes is spaced apart from an end portion of the optical waveguide on a first side, and the second one of the second electrodes is spaced apart from an end portion of the optical waveguide on a second side. The optical modulator further includes a low-permittivity layer with a lower permittivity than that of the optical waveguide. The low-permittivity layer at least partially covers surfaces of the second electrodes to be interposed between the second electrodes and the third electrode (fourth structure).

The optical modulator in the fourth structure preferably includes the following structure. The low-permittivity layer at least partially covers a surface of the first electrode to be interposed between the first electrode and the third electrode (fifth structure).

In the optical modulator in the fourth structure, the electric fields directed from the second electrodes to the optical waveguide pass through the low-permittivity layer. In the optical modulator in the fifth structure, the electric field directed from the first electrode to the optical waveguide passes through the low-permittivity layer. Compared to the structure not including the low-permittivity layer, the effective refractive index perceived by the electric signal thus decreases. Normally, the effective refractive index perceived by the electric signal is higher than the effective refractive index perceived by the light wave. The difference between the effective refractive index perceived by the electric signal and the effective refractive index perceived by the light wave is thus reduced. The modulation frequency can thus be enhanced.

The optical modulator preferably includes an auxiliary low-permittivity layer with a lower permittivity than the optical waveguide. The auxiliary low-permittivity layer at least partially covers a surface of the third electrode to be interposed between the second electrodes and the third electrode (sixth structure).

In the optical modulator in the sixth structure, the electric fields directed from the second electrodes to the optical waveguide pass through the auxiliary low-permittivity layer. Compared to a structure not including the auxiliary low-permittivity layer, the effective refractive index perceived by the electric signal thus decreases. The difference between the effective refractive index perceived by the electric signal and the effective refractive index perceived by the light wave is thus reduced. The modulation frequency can thus be enhanced.

The above optical modulator preferably has the following structure. The material of the optical waveguide is LiNbO₃ (seventh structure). LiNbO₃ (lithium niobate) has a particularly high electrooptic effect. Herein, LiNbO₃ may be denoted with LN. The optical waveguide may be formed from any material that has an electrooptic effect. For example, the material of the optical waveguide may be, for example, lithium tantalate (LiTaO₃), lead lanthanum zirconate titanate (PLZT), potassium tantalum niobium oxide (KTN), or barium titanate (BaTiO₃).

The above optical modulator may further include a substrate on which the optical waveguide is provided (eighth structure).

The optical modulator in the eighth structure may have the following structure. The substrate includes an identical material to the optical waveguide, and the optical waveguide is a ridge waveguide (ninth structure). This structure can further confine light within the optical waveguide. The periphery of the optical waveguide except for the boundary with the substrate can be covered with the low-permittivity layer. This structure facilitates an adjustment of the effective refractive index.

Alternatively, the optical waveguide may be formed by diffusing titanium (Ti) in a substrate. The optical waveguide can also be formed by a proton exchange method.

An optical modulator in any one of the first to seventh structures may include two optical modulator units parallel or substantially parallel to each other, and each including the optical waveguide and the control electrodes (tenth structure).

The optical modulator in the tenth structure is a Mach-Zehnder optical modulator. In this case, the optical modulator also enables intensity modulation in addition to the phase modulation. The optical modulator thus enables multivalued modulation, and can increase the transmission capacity. The optical modulator in the tenth structure achieves the same advantageous effects as the optical modulators of the first to seventh structures.

The optical modulator in the tenth structure may have the following structure. Each of the optical modulator units further includes a substrate on which the optical waveguide is provided, and the substrate in a first one of the two optical modulator units is parallel or substantially parallel with the substrate in a second one of the two optical modulator units (eleventh structure).

The optical modulator in the eleventh structure may have the following structure. In each of the optical modulator units, the substrate includes an identical material to the optical waveguide, and the optical waveguide is a ridge waveguide (twelfth structure). The optical modulator in the twelfth structure corresponds to the optical modulator in the ninth structure. As in the optical modulator in the ninth structure, the optical modulator in the twelfth structure can thus further confine light within itself, and can facilitate an adjustment of the effective refractive index.

The optical modulator in the eleventh structure or the twelfth structure may have the following structure. The substrate in the first one of the two optical modulator units is integrated with the substrate in the second one of the two optical modulator units. The first electrode and the second electrode in the first optical modulator unit receive a voltage with an opposite phase to a voltage applied to the first electrode and the second electrode in the second optical modulator unit (thirteenth structure).

In the optical modulator in the thirteenth structure, the substrate of the first optical modulator unit and the substrate of the second optical modulator unit can be used in common. The distance between the optical waveguide of the first optical modulator unit and the optical waveguide of the second optical modulator unit can thus be reduced. In this case, the width of the entirety of the optical modulator can be reduced.

The optical modulator according to the eleventh structure or the twelfth structure may have the following structure. The substrate in the first one of the two optical modulator units is integrated with the substrate in the second one of the two optical modulator units. The optical waveguide in the first one of the two optical modulator units and the optical waveguide in the second one of the two optical modulator units have spontaneous polarization reversed from each other. One of the two second electrodes in the first one of the two optical modulator units is integrated with one of the two second electrodes in the second one of the two optical modulator units. The first electrode and the second electrode in the first one of the two optical modulator units receive a voltage with an identical phase to a voltage applied to the first electrode and the second electrode in the second one of the two optical modulator units (fourteenth structure).

In the optical modulator in the fourteenth structure, the second electrodes close to each other are integrated and used in common. The distance between the optical waveguide of the first optical modulator unit and the optical waveguide of the second optical modulator unit can be thus further reduced. In this case, the width of the entirety of the optical modulator can be further reduced.

Some example embodiments of the present disclosure are described below with reference to the drawings. The same or corresponding components throughout the drawings are denoted with the same reference signs without redundant description.

### First Example Embodiment

### Structure of Optical Modulator 100

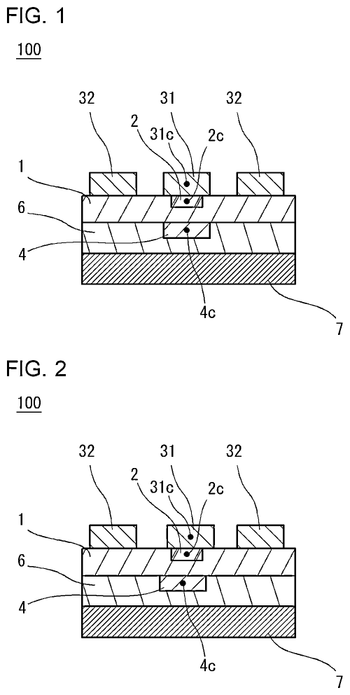

FIG. 1 is a schematic cross-sectional view of an optical modulator 100 according to a first example embodiment. FIG. 1 is a cross-sectional view perpendicular to a direction in which an optical waveguide 2 extends. The direction in which the optical waveguide 2 extends can be rephrased as a direction along the optical waveguide 2. Herein, unless otherwise particularly noted, the cross section means a cross section taken perpendicular or substantially perpendicular to a direction in which the optical waveguide 2 or optical waveguides 2A and 2B described below extend. In the cross section of the optical modulator 100, a support plate 7 that supports the entire structure is provided at the lowest, the thickness direction of the optical modulator 100 corresponds to the vertical direction, and the width direction of the optical modulator 100 corresponds to the lateral direction. Herein, up, down, left, and right are defined for the sake of explanation, not for limiting the posture of the actual optical modulator 100.

With reference to FIG. 1, the optical modulator 100 includes a substrate 1, an optical waveguide 2, a first electrode 31, two second electrodes 32, and a third electrode 4. The first electrode 31, the two second electrodes 32, and the third electrode 4 are included in the control electrodes to control light that passes through the optical waveguide 2.

Each of the first electrode 31 and the two second electrodes 32 is located on the substrate 1. Each of the second electrodes 32 receives a voltage with the same phase as the voltage applied to the first electrode 31. The third electrode 4 generates a potential difference from a group of the first electrode 31 and the second electrodes 32. The first electrode 31 and the second electrodes 32 are, for example, signal electrodes. The third electrode 4 is, for example, a ground electrode. The third electrode 4 may be an inverse signal electrode that receives the voltage with the opposite phase to the voltage applied to the first electrode 31 and the second electrodes 32.

The third electrode 4 is below the substrate 1. The optical modulator 100 according to the present example embodiment further includes an auxiliary low-permittivity layer 6. The substrate 1, the optical waveguide 2, the first electrode 31, the second electrodes 32, the third electrode 4, and the auxiliary low-permittivity layer 6 are supported by the support plate 7. The support plate 7 is located lowest.

The optical waveguide 2 is including a material with an electrooptic effect. The material of the optical waveguide 2 is, for example, LN. The optical waveguide 2 is provided on the substrate 1. More specifically, the optical waveguide 2 is provided at an upper portion of the substrate 1. The optical waveguide 2 is formed by diffusing Ti into the substrate 1. A portion of the substrate 1 in which Ti is diffused has a high index of refraction, and can confine light. The portion is thus usable as the optical waveguide 2.

The optical waveguide 2 can have, for example, a cross section with a width (a dimension in the lateral direction) greater than a thickness (a dimension in the vertical direction). In FIG. 1, the cross-sectional shape of the optical waveguide 2 is roughly rectangular, with a substantially wide width. In this case, the cross-sectional shape of the optical waveguide 2 includes a first side extending in the width direction and a second side extending in the width direction and parallel or substantially parallel with the first side. The cross-sectional shape of the optical waveguide 2 further includes a third side and a fourth side each extending in the thickness direction. In the example illustrated in FIG. 1, the first side and the second side are a pair of long sides, and the third side and the fourth side are a pair of short sides. When the cross-sectional shape of the optical waveguide 2 is rectangular or substantially rectangular, with a wide width, a first long side (a first side on the upper side) of the pair of long sides is provided on the surface of the substrate 1, and a second long side (a second side on the lower side) is provided inside the substrate 1.

In the cross section of the optical waveguide 2, the first side and the second side serving as the long sides are connected to each other with the third side and the fourth side serving as the short sides. In the example illustrated in FIG. 1, the third side and the fourth side of the optical waveguide 2 are straight in the cross-sectional view of the optical modulator 100, and are parallel or substantially parallel to the thickness direction of the optical waveguide 2. Instead, the third side and the fourth side may be inclined with respect to the thickness direction of the optical waveguide 2, or may be other than straight. In the cross-sectional view of the optical modulator 100, the third side and the fourth side of the optical waveguide 2 may have a curved shape or a shape of a combination of a straight line and a curve. The length of the third side may be the same as or different from the length of the fourth side. Similarly, the length of the first side may be the same as or different from the length of the second side.

The cross-sectional shape of the optical waveguide 2 may be semi-elliptic, with a wide width. In this case, the cross-sectional shape of the optical waveguide 2 includes a base serving as a long axis extending in the width direction, and an elliptic-arc side extending in the width direction. When the cross-sectional shape of the optical waveguide 2 has a semi-elliptic shape with a wide width, the base is provided on the surface of the substrate 1, and the elliptic-arc side is provided inside the substrate 1.

The first electrode 31, the second electrode 32, and the third electrode 4 include a metal material, and each have a rectangular or substantially rectangular cross section. The first electrode 31 is provided on a first side of the optical waveguide 2 in the thickness direction. The third electrode 4 is provided on the second side of the optical waveguide 2 in the thickness direction. For example, the first electrode 31 is provided on the optical waveguide 2. In this case, the first electrode 31 is provided substantially directly above the optical waveguide 2. The third electrode 4 is provided under the optical waveguide 2. In this case, the third electrode 4 is provided substantially directly below the optical waveguide 2. The first one of the two second electrodes 32 is spaced apart from the first electrode 31 on the first side of the first electrode 31 in the width direction of the optical waveguide 2. The second one of the two second electrodes 32 is spaced apart from the first electrode 31 on the second side of the first electrode 31 in the width direction of the optical waveguide 2. The first electrode 31 is thus between the second electrodes 32. In the width direction of the optical waveguide 2, the first one of the second electrodes 32 is spaced apart from the end portion of the optical waveguide 2 on a first side, and the second one of the second electrodes 32 is spaced apart from the end portion of the optical waveguide 2 on a second side.

In short, the first electrode 31 and the third electrode 4 are positioned to hold the optical waveguide 2 therebetween in the vertical direction (thickness direction). The two second electrodes 32 are adjacent to the first electrode 31 and spaced apart from the first electrode 31 to hold the first electrode 31 therebetween in the lateral direction (width direction) with respect to the optical waveguide 2.

In the present example embodiment, the position of a center 31c of the first electrode 31 in the width direction (lateral direction) is at the middle portion of the optical waveguide 2 in the width direction. The center 31c of the first electrode 31 is, for example, within a range of a center one of trisected areas of the optical waveguide 2 in the width direction of the optical waveguide 2. For example, the position of the center 31c of the first electrode 31 in the width direction may agree with the position of a center 2c of the optical waveguide 2 in the width direction. The position of a center 4c of the third electrode 4 in the width direction is at the middle portion of the optical waveguide 2 in the width direction. The center 4c of the third electrode 4 is within a range of a center one of trisected areas of the optical waveguide 2 in the width direction of the optical waveguide 2. For example, the position of the center 4c of the third electrode 4 in the width direction may agree with the position of the center 2c of the optical waveguide 2 in the width direction. In this case, the position of the center 31c of the first electrode 31, the position of the center 4c of the third electrode 4, and the position of the center 2c of the optical waveguide 2 agree with one another in the width direction without misalignment. In another aspect, the first electrode 31 is substantially or roughly immediately above the third electrode 4, and the optical waveguide 2 is between the first electrode 31 and the third electrode 4. The two second electrodes 32 are arranged in the width direction of the optical waveguide 2 symmetrically with respect to the first electrode 31.

In the present example embodiment, the auxiliary low-permittivity layer 6 is provided under the substrate 1. The support plate 7 is provided under the auxiliary low-permittivity layer 6. The third electrode 4 is provided inside the auxiliary low-permittivity layer 6, and is provided under the substrate 1. The auxiliary low-permittivity layer 6 at least partially covers the surfaces of the third electrode 4 to be interposed between the second electrode 32 and the third electrode 4. In the example of the present example embodiment, the auxiliary low-permittivity layer 6 directly covers the side surfaces and the bottom surface of the third electrode 4. In this case, a portion of the auxiliary low-permittivity layer 6 covering the side surfaces of the third electrode 4 is interposed between the second electrodes 32 and the third electrode 4.

The permittivity of the auxiliary low-permittivity layer 6 is lower than the permittivity of the optical waveguide 2. The material of the auxiliary low-permittivity layer 6 may be any material having a permittivity lower than the permittivity of the optical waveguide 2. The material of the auxiliary low-permittivity layer 6 is, for example, SiO₂. An oxide (such as Al₂O₃, SiO₂, LaAlO₃, LaYO₃, Zno, HfO₂, MgO, or Y₂O₃) is used as the auxiliary low-permittivity layer 6. Instead, a polymer (such as benzocyclobutene (BCB) or polyimide (PI)) may be used as the auxiliary low-permittivity layer 6.

Instead, the auxiliary low-permittivity layer 6 may be eliminated. When the auxiliary low-permittivity layer 6 is eliminated, the third electrode 4 may be provided at any position below the substrate 1. In another aspect, the third electrode 4 may be buried under the substrate 1.

### Advantageous Effects

In the present example embodiment, the first electrode 31 and the third electrode 4 are positioned to hold the optical waveguide 2 therebetween in the thickness direction. In addition, the two second electrodes 32 are adjacent to the first electrode 31 and spaced apart from the first electrode 31 to hold the first electrode 31 therebetween in the width direction, on the same side of the optical waveguide 2 in the thickness direction. In other words, the first electrode 31 and the two second electrodes 32 that generate a potential difference from the third electrode 4 are separately provided. In addition, spaces are provided between the first electrode 31 and the second electrodes 32.

In the optical modulator 100 according to the present example embodiment, during an operation of the optical modulator 100, the first electrode 31 and the two second electrodes 32 provided on the same side of the optical waveguide 2 in the thickness direction receive a voltage of the same phase. The third electrode 4 generates a potential difference from a group of the first electrode 31 and the second electrodes 32. The electric fields thus individually operate from the first electrode 31 and the second electrodes 32 toward the third electrode 4, and the electric fields are applied to the optical waveguide 2. All the electric fields directed from the first electrode 31 then pass through the optical waveguide 2. Almost all the electric fields directed from the second electrodes 32 pass through the optical waveguide 2. More specifically, in addition to the electric field from the first electrode 31, the electric fields directed from the two second electrodes 32 pass through the optical waveguide 2. Compared to the structure including a single signal electrode and a ground electrode provided on the same side of the optical waveguide 2 in the thickness direction, the efficiency of electric-field application to the optical waveguide 2 can thus be improved.

In the present example embodiment, the auxiliary low-permittivity layer 6 is interposed between the second electrodes 32 and the third electrode 4. The electric fields directed from the second electrodes 32 thus pass through the auxiliary low-permittivity layer 6. The effective refractive index perceived by the electric signal thus decreases. The difference between the effective refractive index perceived by the electric signal and the effective refractive index perceived by the light wave is thus reduced. The modulation frequency can thus be enhanced.

When the first electrode 31 and the two second electrodes 32 are provided on the same side of the optical waveguide 2 in the thickness direction, and the first electrode 31 and the third electrode 4 are provided to hold the optical waveguide 2 therebetween in the thickness direction, the electric fields can be applied from the first electrode 31 and the two second electrodes 32 to the optical waveguide 2. Compared to a case where a single signal electrode and a ground electrode are provided to hold the optical waveguide therebetween in the thickness direction, the electric fields can thus be easily applied to the optical waveguide 2, the effective refractive index can be easily adjusted, and the freedom of design of the structure of the optical modulator can be enhanced.

The impedance of the signal electrode that generates a potential difference from the third electrode 4 is ideally 50Ω, for example. In the present example embodiment, the first electrode 31 and the two second electrodes 32 are separately provided as signal electrodes that generate a potential difference from the third electrode 4. In another aspect, a signal electrode that generates a potential difference from the third electrode 4 is divided into three areas. When one signal electrode is divided into three, the impedance of the first electrode 31 and the second electrodes 32 can be approximated to an ideal value of 50Ω while the electric field is applied to the auxiliary low-permittivity layer 6 extending in a wide range or a low-permittivity layer 5 described below, for example. The three signal electrodes enable different settings of voltages to be applied. The intensity of electric field can thus be adjusted to be preferably distributed in accordance with the cross-sectional areas of the auxiliary low-permittivity layer 6 or the low-permittivity layer 5 described below or the shape of the optical waveguide.

In the present example embodiment, three signal electrodes including the first electrode 31 and the two second electrodes 32 are provided as signal electrodes that generate a potential difference from the third electrode 4. The first electrode 31 applies the electric fields to the optical waveguide 2, and the two second electrodes 32 adjust the effective refractive index. The first electrode 31 is preferably provided immediately above the optical waveguide 2 to efficiently and uniformly apply the electric fields to the optical waveguide 2.

The second electrodes 32 are provided on the sides of the first electrode 31, and thus can apply electric fields having a horizontal component to the third electrode 4. The electric field components that pass through the auxiliary low-permittivity layer 6 can thus be increased. In a structure including one second electrode 32, the index of refraction perceived by the optical waveguide 2 in the horizontal direction is imbalanced. The second electrodes 32 are thus provided one on each of the left and right sides of the first electrode 31 to work together to adjust the balance of the effective refractive index in the horizontal direction.

As described above, two second electrodes 32 are preferably provided for one first electrode 31. This is because providing three or more second electrodes 32 cannot yield greater effects than providing two second electrodes 32, and causes a size increase of the device (optical modulator 100). The structure including the first electrode 31 and the two second electrodes 32 is thus most preferable.

In the present example embodiment, the position of the center 31c of the first electrode 31 in the width direction is provided at the middle portion of the optical waveguide 2 in the width direction, and the position of the center 4c of the third electrode 4 in the width direction is provided at the middle portion of the optical waveguide 2 in the width direction. In this case, the first electrode 31 is provided substantially or roughly immediately above the third electrode 4, and the optical waveguide 2 is provided between the first electrode 31 and the third electrode 4. The intensity of electric field directed from the first electrode 31 to the third electrode 4 can thus be enhanced, and the efficiency of electric-field application to the optical waveguide 2 can be enhanced.

In the present example embodiment, the two second electrodes 32 are symmetrically arranged in the width direction of the optical waveguide 2 with respect to the first electrode 31. The second electrodes 32 arranged symmetrically can apply the electric field in a well-balanced manner. This structure can reduce disparity in effective refractive index and reduce the optical loss.

In the present example embodiment, the third electrode is not provided on the side of the optical waveguide 2 on which the first electrode 31 and the second electrodes 32 are provided. The third electrode is an electrode that generates a potential difference from a group of the first electrode 31 and the second electrodes 32. If a third electrode is provided on the side of the optical waveguide 2 on which the first electrode 31 and the second electrodes 32 are provided, undeniably, the electric fields directed from the first electrode 31 and the second electrodes 32 partially leak to the third electrode. This structure cannot be considered as a high having efficiency of electric-field application to the optical waveguide 2. In this respect, in the present example embodiment, the third electrode is not provided on the side of the optical waveguide 2 on which the first electrode 31 and the second electrodes 32 are provided. As described above, the present example embodiment can thus improve the efficiency of electric-field application to the optical waveguide 2.

### Dimensions of First Electrode 31, Second Electrodes 32, and Third Electrode 4

As the distance between the first electrode 31 and each of the second electrodes 32 in the width direction increases, the effective refractive index and the impedance increase. As the thickness of the first electrode 31 and the second electrodes 32 (film thickness) increases, the effective refractive index and the impedance decrease. As the width of the first electrode 31 and the second electrodes 32 increases, the effective refractive index increases and the impedance decreases. For example, when an ideal impedance value is 50Ω, and the effective refractive index perceived by the electric signal and the effective refractive index perceived by the light wave are approximated, the modulation rate of the optical signal can be improved.

The dimension of the third electrode 4 in the width direction is preferably the same as or smaller than the width of the optical waveguide 2, for enhancement of the electric-field application efficiency. The dimension of the first electrode 31 in the width direction is preferably the same as or smaller than the width of the optical waveguide 2, for enhancement of the electric-field application efficiency. The dimension of each second electrode 32 in the width direction is preferably the same as or greater than the dimension of the first electrode 31 in the width direction. Instead, the dimension of each second electrode 32 in the width direction may be smaller than the dimension of the first electrode 31 in the width direction. The distance (gap) between the first electrode 31 and each second electrode 32 in the width direction is preferably the same as or greater than the dimension of the first electrode 31 in the width direction. The dimension of the first electrode 31 in the width direction and the dimension of each second electrode 32 in the width direction may be designed to allow the first electrode 31 and the second electrodes 32 to have substantially the same impedance, or in term of restriction of the reduction of the modulation rate, may be designed to allow the impedance to be approximate to 50Ω or within a range of about 50 Ω±10Ω, for example. The distance between the first electrode 31 and each of the second electrodes 32 may be set not to allow the effective refractive index perceived by the electric signal to fall under the index of refraction of the optical waveguide 2.

The dimension of the first electrode 31 in the width direction may be greater than the width of the optical waveguide 2. In this case, the dimension of the third electrode 4 in the width direction may be greater than the width of the optical waveguide 2, but preferably smaller than the dimension of the first electrode 31 in the width direction. When the dimension of the first electrode 31 in the width direction is greater than the width of the optical waveguide 2, the electric field directed from the first electrode 31 partially passes through the auxiliary low-permittivity layer 6 before arriving at the third electrode 4. The effective refractive index perceived by the electric signal can thus be further reduced. The difference between the effective refractive index perceived by the electric signal and the effective refractive index perceived by the light wave can thus be further reduced, and the modulation frequency can be enhanced.

### Method for Manufacturing Optical Modulator 100 According to First Example Embodiment

An example of a method for manufacturing the optical modulator 100 according to a first example embodiment is described below. The substrate 1 formed from a material with an electrooptic effect is prepared. The third electrode 4 is formed on the substrate 1. For example, the third electrode 4 can be formed by patterning with, for example, photolithography, vapor deposition, or liftoff. The third electrode 4 may be formed by photolithography and plating. Instead, the third electrode 4 may be formed by deposition, for example, vapor deposition, sputtering, or chemical Vapor deposition (CVD), patterning through photolithography, and then etching.

On the surface of the substrate 1 on which the third electrode 4 is provided, the auxiliary low-permittivity layer 6 is deposited. The auxiliary low-permittivity layer 6 has a lower permittivity than the substrate 1. The thickness of the auxiliary low-permittivity layer 6 is greater than the thickness of the third electrode 4.

The substrate 1 is joined to the support plate 7. The joint surface of the substrate 1 is a surface on which the third electrode 4 and the auxiliary low-permittivity layer 6 are provided. The joining method is, for example, surface activated bonding or atomic diffusion bonding.

The surface of the substrate 1 opposite to the joint surface is processed to thin the substrate 1 to a desired thickness. The method for thinning the substrate 1 is, for example, grinding or chemical-mechanical polishing (CMP). Instead, the substrate 1 may be thinned by using a release layer with a desired film thickness formed in advance through ion implantation and released after joining, and being finished with grinding or chemical-mechanical polishing (CMP). The thinned substrate 1 has a thickness of smaller than or equal to about 10 μm, for example.

The optical waveguide 2 is formed on the substrate 1 by Ti diffusion or a proton exchange method.

The first electrode 31 and the two second electrodes 32 are formed on the surface of the substrate 1 on which the optical waveguide 2 is provided. Each of the electrodes 31 and 32 is preferably thicker, because the thicker electrodes 31 and 32 further reduce the loss of signal. The width and the thickness of the second electrodes 32 arranged on the left and right sides are preferably the same as or greater than the width and the thickness of the first electrode 31 provided at the middle. For example, each of the electrodes 31 and 32 can be formed by patterning, for example, photolithography, vapor deposition, or liftoff. Each of the electrodes 31 and 32 may be formed by photolithography and plating. Instead, each of the electrodes 31 and 32 may be formed by depositing such as vapor deposition, sputtering, or CVD, patterning with photolithography, and etching.

### First Modification Example of First Example Embodiment

FIGS. 2 to 4 are schematic diagrams of a first modification example of the optical modulator 100 according to the first example embodiment. FIGS. 2 to 4 illustrate cross sections of the optical modulator 100. In the first modification example, the structures of the first electrode 31, the second electrodes 32, and the third electrode 4 with respect to the optical waveguide 2 are changed from those in the optical modulator 100 illustrated in FIG. 1.

In the example illustrated in FIG. 2, the first electrode 31 is shifted toward a first one (right in FIG. 2) of the two sides of the optical waveguide 2 in the width direction with respect to the optical waveguide 2, and the third electrode 4 is shifted toward a second one (left in FIG. 2) of the two sides of the optical waveguide 2 in the width direction. In this case, the position of the center 31c of the first electrode 31 in the width direction does not agree with the position of the center 2c of the optical waveguide 2 in the width direction. The position of the center 4c of the third electrode 4 in the width direction does not agree with the position of the center 2c of the optical waveguide 2 in the width direction. More specifically, the position of the center 31c of the first electrode 31, the position of the center 4c of the third electrode 4, and the position of the center 2c of the optical waveguide 2 do not agree with one another in the width direction, or are misaligned from one another.

In the example illustrated in FIG. 2, the distance between the right second electrode 32 and the first electrode 31 is smaller than the distance between the left second electrode 32 and the first electrode 31. Specifically, the two second electrodes 32 are arranged in the width direction of the optical waveguide 2 asymmetrically with respect to the first electrode 31.

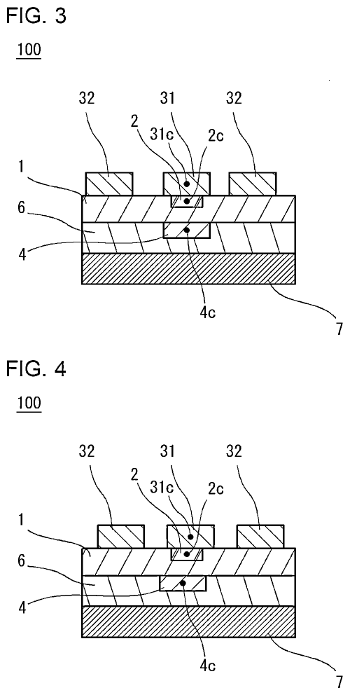

In the example illustrated in FIG. 3, the position of the center 31c of the first electrode 31 in the width direction agrees with the position of the center 2c of the optical waveguide 2 in the width direction. The position of the center 4c of the third electrode 4 in the width direction agrees with the position of the center 2c of the optical waveguide 2 in the width direction. More specifically, as in the optical modulator 100 illustrated in FIG. 1, the position of the center 31c of the first electrode 31, the position of the center 4c of the third electrode 4, and the position of the center 2c of the optical waveguide 2 agree with one another in the width direction, or are not misaligned from one another.

In the example illustrated in FIG. 3, the distance between the right second electrode 32 and the first electrode 31 is smaller than the distance between the left second electrode 32 and the first electrode 31. More specifically, as in the optical modulator 100 according to the first modification example illustrated in FIG. 2, the two second electrodes 32 are arranged in the width direction of the optical waveguide 2 asymmetrically with respect to the first electrode 31.

In the example illustrated in FIG. 4, with respect to the optical waveguide 2, the first electrode 31 is shifted to a first one (right in FIG. 4) of the two sides of the optical waveguide 2 in the width direction, and the third electrode 4 is shifted to a second one (left in FIG. 4) of the two sides of the optical waveguide 2 in the width direction. In this case, as in the optical modulator 100 of the first modification example illustrated in FIG. 2, the position of the center 31c of the first electrode 31 in the width direction does not agree with the position of the center 2c of the optical waveguide 2 in the width direction. The position of the center 4c of the third electrode 4 in the width direction does not agree with the position of the center 2c of the optical waveguide 2 in the width direction.

In the example illustrated in FIG. 4, the distance between the right second electrode 32 and the first electrode 31 agrees with the distance between the left second electrode 32 and the first electrode 31. More specifically, as in the optical modulator 100 illustrated in FIG. 1, the two second electrodes 32 are arranged in the width direction of the optical waveguide 2 symmetrically with respect to the first electrode 31.

In the first modification example, with respect to the optical waveguide 2, only one of the first electrode 31 and the third electrode 4 may be shifted in the width direction. More specifically, the position of the center 31c of the first electrode 31 in the width direction may disagree with the position of the center 2c of the optical waveguide 2 in the width direction, and the position of the center 4c of the third electrode 4 in the width direction may agree with the position of the center 2c of the optical waveguide 2 in the width direction. The position of the center 4c of the third electrode 4 in the width direction may disagree with the position of the center 2c of the optical waveguide 2 in the width direction, and the position of the center 31c of the first electrode 31 in the width direction may agree with the position of the center 2c of the optical waveguide 2 in the width direction.

### Second Example Embodiment

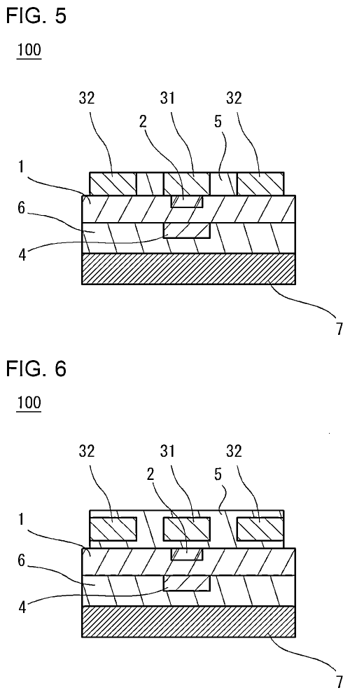

FIG. 5 is a schematic cross-sectional view of an optical modulator 100 according to a second example embodiment. The optical modulator 100 according to the present example embodiment is a modification of the optical modulator 100 according to the first example embodiment.

With reference to FIG. 5, the optical modulator 100 further includes low-permittivity layers 5. More specifically, the low-permittivity layers 5 are laminated on the substrate 1. The low-permittivity layers 5 at least partially cover the surfaces of the second electrodes 32 to be interposed between the second electrodes 32 and the third electrode 4. More specifically, the low-permittivity layers 5 are provided between the first electrode 31 and the second electrodes 32. Specifically, the low-permittivity layers 5 directly cover the side surfaces of the first electrode 31 and the second electrodes 32. The low-permittivity layers 5 are thus partially interposed between the second electrodes 32 and the third electrode 4.

As in the auxiliary low-permittivity layer 6, the permittivity of the low-permittivity layers 5 is lower than the permittivity of the optical waveguide 2. The material of the low-permittivity layers 5 may be any material with a permittivity lower than the permittivity of the optical waveguide 2. The material of the low-permittivity layers 5 may be the same as or different from the material of the auxiliary low-permittivity layer 6.

In the optical modulator 100 according to the present example embodiment, the low-permittivity layers 5 are interposed between the second electrodes 32 and the third electrode 4. The electric fields directed from the second electrodes 32 toward the optical waveguide 2 thus pass through the low-permittivity layers 5. Compared to a structure not including a low-permittivity layer, the effective refractive index perceived by the electric signal thus decreases. The difference between the effective refractive index perceived by the electric signal and the effective refractive index perceived by the light wave is thus reduced. The modulation frequency can thus be enhanced.

In the present example embodiment, the low-permittivity layers 5 are provided between the first electrode 31 and the second electrodes 32. When the second electrodes 32 are assumed as ground electrodes, a large potential difference occurs between the first electrode 31 and the ground electrodes. In this case, when any member is provided between the first electrode 31 and the ground electrodes, a short circuit is highly likely to occur between the first electrode 31 and the ground electrodes. When a short circuit occurs between the first electrode 31 and the ground electrodes, the electric field directed from the first electrode 31 toward the optical waveguide 2 decreases. When the second electrodes 32 are ground electrodes, providing any member between the first electrode 31 and the ground electrodes is thus unlikely.

In the present example embodiment, in contrast, the first electrode 31 and the second electrodes 32 receives a voltage of the same phase, and no potential difference occurs between the first electrode 31 and the second electrodes 32. Regardless of when the distance between the first electrode 31 and each of the second electrodes 32 is short and the second electrodes 32 are arranged adjacent to the first electrode 31, the low-permittivity layers 5 can be provided between the first electrode 31 and the second electrodes 32. The distance between the first electrode 31 and each of the second electrodes 32 may be set to allow the effective refractive index perceived by the electric signal to approximate to the effective refractive index perceived by the light wave passing through the optical waveguide 2.

### Third Example Embodiment

FIG. 6 is a schematic cross-sectional view of an optical modulator 100 according to a third example embodiment. The optical modulator 100 according to the present example embodiment is a modification of the optical modulator 100 according to the second example embodiment.

With reference to FIG. 6, the first electrode 31 and the second electrodes 32 are provided above the substrate 1. The first electrode 31 and the second electrodes 32 are provided inside the low-permittivity layer 5 laminated on the substrate 1. In the example illustrated in FIG. 6, the low-permittivity layer 5 directly covers the bottom surface, the side surfaces, and the top surface of the first electrode 31. The low-permittivity layer 5 also directly covers the bottom surface, the side surface facing the first electrode 31, and the top surface of each of the second electrodes 32. More specifically, the low-permittivity layer 5 at least partially covers the surfaces of the second electrodes 32 to be interposed between the second electrodes 32 and the third electrode 4. The low-permittivity layer 5 also at least partially covers the surface of the first electrode 31 to be interposed between the first electrode 31 and the third electrode 4. In another aspect, the low-permittivity layer 5 covers the entirety of the top surface of the optical waveguide 2 and the top surface of the substrate 1 around the optical waveguide 2.

In the optical modulator 100 according to the present example embodiment, the low-permittivity layer 5 at least partially covers the surfaces of the second electrodes 32 to be interposed between the second electrodes 32 and the third electrode 4. The optical modulator 100 according to the present example embodiment thus obtains the same effects as those according to the second example embodiment. The low-permittivity layer 5 at least partially covers the surface of the first electrode 31 to be interposed between the first electrode 31 and the third electrode 4. Particularly, in the example illustrated in FIG. 6, the low-permittivity layer 5 covers the entirety of the top surface of the optical waveguide 2 and the top surface of the substrate 1 around the optical waveguide 2. The low-permittivity layer 5 is interposed between the first electrode 31 and the optical waveguide 2, and between the second electrodes 32 and the optical waveguide 2. In this case, the electric fields directed from the second electrodes 32 toward the optical waveguide 2 pass through the low-permittivity layer 5, and the electric field directed from the first electrode 31 toward the optical waveguide 2 passes through the low-permittivity layer 5. The effective refractive index perceived by the electric signal can thus be further reduced. The difference between the effective refractive index perceived by the electric signal and the effective refractive index perceived by the light wave is thus further reduced. The modulation frequency is thus further effectively enhanced.

### Second Modification Examples of Second and Third Example Embodiments

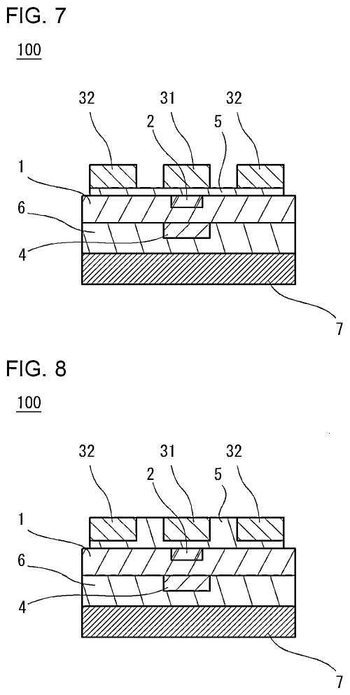

FIGS. 7 to 9 are schematic diagrams of second modification examples of the optical modulators 100 according to the second and third example embodiments. FIGS. 7 to 9 illustrate the cross sections of the optical modulators 100. In the second modification examples, the structure of the low-permittivity layer 5 is changed from that in the optical modulators 100 illustrated in FIGS. 5 and 6.

In the example illustrated in FIG. 7, the low-permittivity layer 5 directly covers the bottom surface of the first electrode 31. The low-permittivity layer 5 directly covers the bottom surfaces of the second electrodes 32.

In the example illustrated in FIG. 8, the low-permittivity layer 5 directly covers the bottom surface and the side surfaces of the first electrode 31. The low-permittivity layer 5 directly covers the bottom surfaces and the side surfaces of the second electrodes 32.

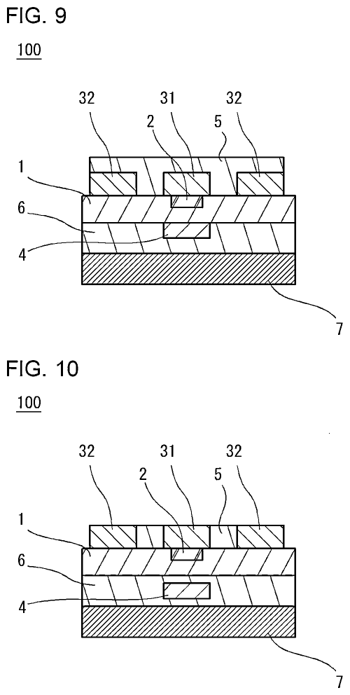

In the example illustrated in FIG. 9, the low-permittivity layer 5 directly covers the side surfaces and the top surface of the first electrode 31. The low-permittivity layer 5 directly covers the side surfaces and the top surfaces of the second electrodes 32.

### Third Modification Examples According to Second and Third Example Embodiments

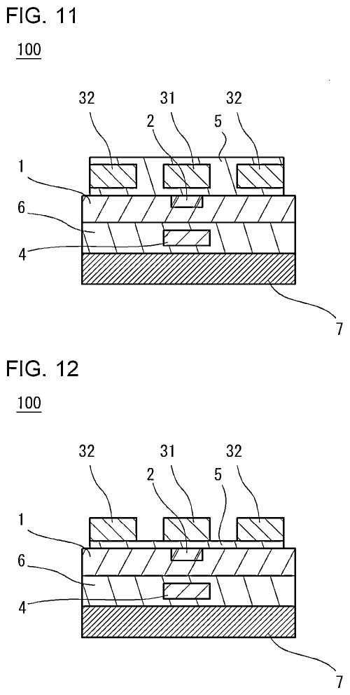

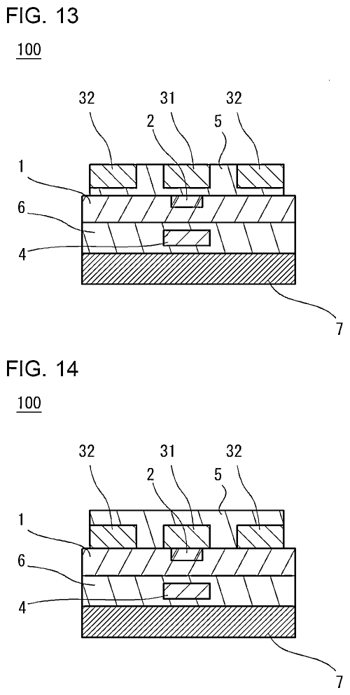

FIGS. 10 to 14 are schematic diagrams of third modification examples of the optical modulators 100 according to the second and third example embodiments. FIGS. 10 to 14 illustrate the cross sections of the optical modulators 100. In each of the third modification examples, the structure of the auxiliary low-permittivity layer 6 is changed from those of the optical modulators 100 illustrated in FIGS. 5 to 9. The optical modulator 100 illustrated in FIG. 10 corresponds to the optical modulator 100 illustrated in FIG. 5. The optical modulator 100 illustrated in FIG. 11 corresponds to the optical modulator 100 illustrated in FIG. 6. The optical modulator 100 illustrated in FIG. 12 corresponds to the optical modulator 100 illustrated in FIG. 7. The optical modulator 100 illustrated in FIG. 13 corresponds to the optical modulator 100 illustrated in FIG. 8. The optical modulator 100 illustrated in FIG. 14 corresponds to the optical modulator 100 illustrated in FIG. 9.

In each of the examples illustrated in FIGS. 10 to 14, the third electrode 4 is provided below the substrate 1. The third electrode 4 is provided inside the auxiliary low-permittivity layer 6 provided under the substrate 1. The auxiliary low-permittivity layer 6 thus directly covers the bottom surface, the side surfaces, and the top surface of the third electrode 4. More specifically, the auxiliary low-permittivity layer 6 at least partially covers the surface of the third electrode 4 to be interposed between the second electrodes 32 and the third electrode 4, and at least partially covers the surface of the third electrode 4 to be interposed between the first electrode 31 and the third electrode 4.

In the optical modulators 100 according to the third modification examples, the electric fields directed from the second electrodes 32 toward the optical waveguide 2 pass through the auxiliary low-permittivity layer 6, and the electric field directed from the first electrode 31 toward the optical waveguide 2 further passes through the auxiliary low-permittivity layer 6. The effective refractive index perceived by the electric signal can thus be further reduced. The difference between the effective refractive index perceived by the electric signal and the effective refractive index perceived by the light wave is thus further reduced. The modulation frequency is thus further effectively enhanced.

### Fourth Example Embodiment

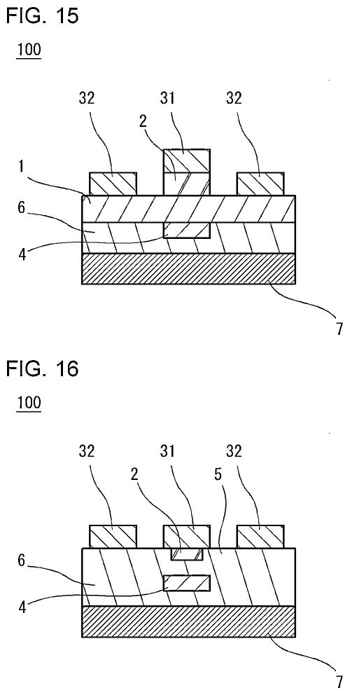

FIG. 15 is a schematic cross-sectional view of an optical modulator 100 according to a fourth example embodiment. The optical modulator 100 according to the present example embodiment is a modification of the optical modulator 100 according to the first example embodiment.

With reference to FIG. 15, the substrate 1 includes a ridge optical waveguide 2. More specifically, the substrate 1 has a raised strip at an upper portion, and the raised strip functions as an optical waveguide 2. A raised strip is formed on the substrate 1 by processing a wafer serving as a material. The raised strip can confine light in its thickness direction and its width direction. The ridge optical waveguide 2 has a roughly rectangular cross section. The cross-sectional shape of the ridge optical waveguide 2 is usually trapezoidal in a strict sense.

The substrate 1 includes an identical material to the optical waveguide 2. Instead, the material of the substrate 1 may be different from the material of the optical waveguide 2. In this case, the material of the substrate 1 is, for example, Si.

The optical modulator 100 according to the present example embodiment achieves the same advantageous effects as those according to the first example embodiment. In the present example embodiment, the optical waveguide 2 is a ridge waveguide, and light can thus be further confined in the optical waveguide 2. The periphery of the optical waveguide 2 excluding the boundary with the substrate 1 can thus be covered with the low-permittivity layer 5. More specifically, the low-permittivity layer 5 widely covers the surroundings of the optical waveguide 2. The effective refractive index is thus easily adjustable.

The structure of the present example embodiment may be applied to the optical modulators 100 according to the second and third example embodiments.

### Method for Manufacturing Optical Modulator 100 According to Fourth Example Embodiment

An example of a method for manufacturing an optical modulator 100 according to a fourth example embodiment is described below. In the optical modulator 100 according to the fourth example embodiment, the substrate 1 includes the ridge optical waveguide 2. The method for manufacturing the optical modulator 100 according to the fourth example embodiment thus differs from the method for manufacturing the optical modulator 100 according to the first example embodiment in terms of a method for forming the optical waveguide 2, and is the same as the method for manufacturing the optical modulator 100 according to the first example embodiment in the other points. Only the different point is described below. The method for manufacturing the optical modulator 100 according to the fourth example embodiment includes photolithography and etching to process a thinned substrate 1 to form a raised strip. The raised strip defines and functions as the optical waveguide 2.

### Fifth Example Embodiment

FIG. 16 is a schematic cross-sectional view of an optical modulator 100 according to a fifth example embodiment. The optical modulator 100 according to the present example embodiment is a modification of the optical modulators 100 according to the first to third example embodiments.

With reference to FIG. 16, in the present example embodiment, the low-permittivity layer 5 and the auxiliary low-permittivity layer 6 are integrated. In a cross-sectional view of the optical modulator 100, the optical waveguide 2 is provided inside the low-permittivity layer 5 and the auxiliary low-permittivity layer 6 that are integrated. In the example illustrated in FIG. 16, the low-permittivity layers 5 and 6 directly cover the bottom surface and the side surfaces of the optical waveguide 2. The electric fields that pass through the low-permittivity layers 5 and 6 thus increase further, and the effective refractive index is thus more easily adjustable.

In the example illustrated in FIG. 16, the integrated low-permittivity layers 5 and 6 may further cover the top surface of the optical waveguide 2.

### Sixth Example Embodiment

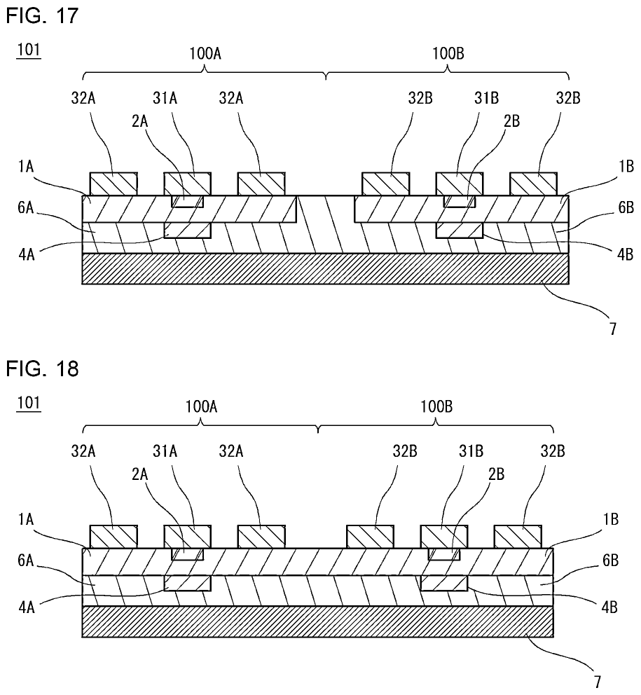

FIG. 17 is a schematic cross-sectional view of an optical modulator 101 according to a sixth example embodiment. The optical modulator 101 according to the present example embodiment is formed from a Mach-Zehnder optical modulator. The optical modulator 101 according to the present example embodiment is a modification of the optical modulator 100 according to the first example embodiment, and includes components of the optical modulator 100 according to the first example embodiment arranged in parallel or substantially in parallel with each other.

With reference to FIG. 17, the optical modulator 101 according to the present example embodiment includes two optical modulator units 100A and 100B.

The optical modulator unit 100A includes a substrate 1A, an optical waveguide 2A, a first electrode 31A, two second electrodes 32A, a third electrode 4A, and an auxiliary low-permittivity layer 6A. The optical modulator unit 100B includes a substrate 1B, an optical waveguide 2B, a first electrode 31B, two second electrodes 32B, a third electrode 4B, and an auxiliary low-permittivity layer 6B. The optical modulator units 100A and 100B are supported by a support plate 7.

The substrates 1A and 1B each correspond to the substrate 1. The optical waveguides 2A and 2B each correspond to the optical waveguide 2. The first electrodes 31A and 31B each correspond to the first electrode 31. The pairs of second electrodes 32A and 32B each correspond to the pair of second electrodes 32. The third electrodes 4A and 4B each correspond to the third electrode 4. The auxiliary low-permittivity layers 6A and 6B each correspond to the auxiliary low-permittivity layer 6.

The substrate 1A on which the optical waveguide 2A is provided is arranged in parallel or substantially in parallel with the substrate 1B on which the optical waveguide 2B is provided. More specifically, the optical waveguides 2A and 2B are arranged side by side. Upstream from the optical waveguides 2A and 2B, a single incident-side optical waveguide is bifurcated into the optical waveguides 2A and 2B. Downstream from the optical waveguides 2A and 2B, the optical waveguides 2A and 2B are merged into a single emerging-side optical waveguide.

The optical modulator 101 according to the present example embodiment can also obtain the same effects as those according to the first example embodiment. In addition, the optical modulator 101 according to the present example embodiment formed from a Mach-Zehnder optical modulator enables intensity modulation in addition to the phase modulation. The optical modulator 101 thus enables multivalued modulation, and can increase the transmission capacity.

The optical modulator 101 according to the present example embodiment may eliminate the auxiliary low-permittivity layers 6A and 6B. The optical modulator units 100A and 100B may each include a low-permittivity layer corresponding to the low-permittivity layer 5 according to the second or third example embodiment. The optical modulator 101 according to the present example embodiment may eliminate the substrates 1A and 1B, as in the optical modulator according to the fifth example embodiment.

In the optical modulator 101 according to the present example embodiment, the optical waveguides 2A and 2B are formed by Ti diffusion. Instead, the optical waveguides 2A and 2B may be ridge waveguides. In this case, the optical modulators achieve the same advantageous effects as those according to the fourth example embodiment.

### Seventh Example Embodiment

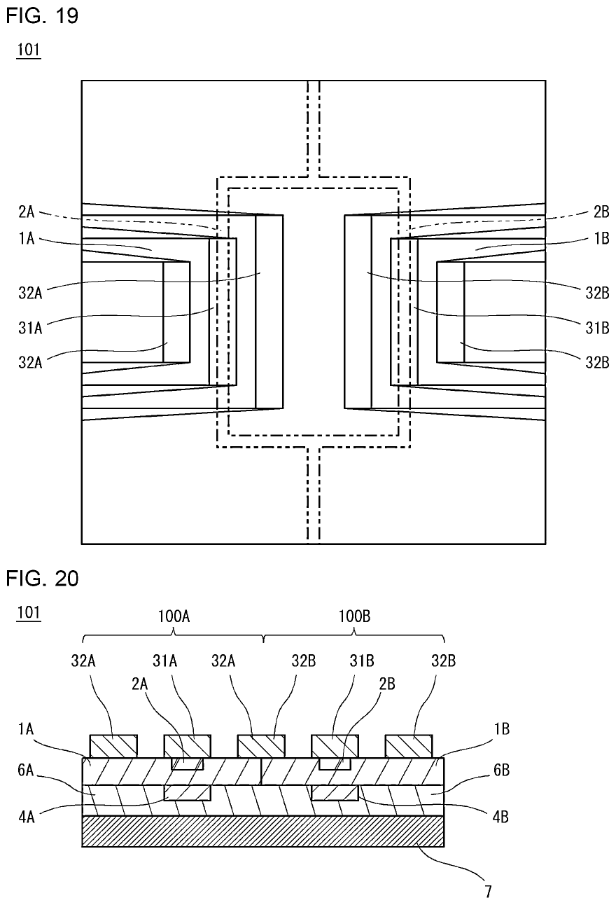

FIGS. 18 and 19 are schematic diagrams illustrating an optical modulator 101 according to a seventh example embodiment. FIG. 18 illustrates a cross section of the optical modulator 101. FIG. 19 is a plan view of the optical modulator 101 viewed from above. The optical modulator 101 according to the present example embodiment is a modification of the optical modulator 101 according to the sixth example embodiment.

With reference to FIGS. 18 and 19, a substrate 1A of an optical modulator unit 100A is integrated with a substrate 1B of an optical modulator unit 100B. In this case, when the optical modulator 101 operates, the first electrode 31B and two second electrodes 32B receive a voltage with the opposite phase to the voltage applied to a first electrode 31A and two second electrodes 32A.

In the optical modulator 101 according to the present example embodiment, the substrates 1A and 1B can be used in common. The optical waveguides 2A and 2B are provided on the substrates 1A and 1B used in common. The distance between the optical waveguides 2A and 2B can thus be reduced. In this case, the width of the entirety of the optical modulator 101 can be reduced, and the size reduction of the optical modulator 101 can be achieved.

### Eighth Example Embodiment

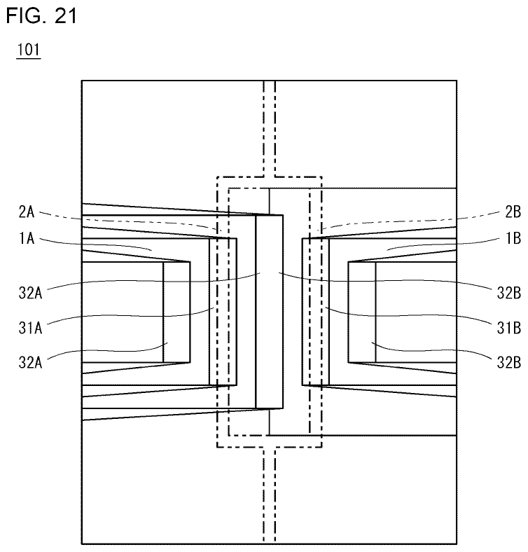

FIGS. 20 and 21 are schematic diagrams of an optical modulator 101 according to an eighth example embodiment. FIG. 20 illustrates a cross section of the optical modulator 101. FIG. 21 is a plan view of the optical modulator 101 viewed from above. The optical modulator 101 according to the present example embodiment is a modification of the optical modulator 101 according to the sixth example embodiment.

With reference to FIGS. 20 and 21, a substrate 1A of the optical modulator unit 100A is integrated with a substrate 1B of the optical modulator unit 100B. An optical waveguide 2A and an optical waveguide 2B have spontaneous polarization reversed from each other. When the substrate 1A and the substrate 1B are formed from a ferroelectric crystal such as LN or LiTaO₃, and a high voltage is applied to the ferroelectric crystal, the spontaneous polarization can be reversed. A portion having reversed polarization can be recognized by observation with an atomic force microscope or an electron microscope. In this case, when the optical modulator 101 operates, the voltage of the same phase is applied to the first electrode 31A, the second electrodes 32A, the first electrode 31B, and the second electrodes 32B.

In the optical modulator 101 according to the present example embodiment, as in the seventh example embodiment, the substrates 1A and 1B are used in common. The optical waveguides 2A and 2B are provided on the substrates 1A and 1B used in common.

One of the two second electrodes 32B is integrated with one of the two second electrodes 32A. More specifically, the second electrode 32A and the second electrode 32B provided close to each other are electrically integrated with each other. In this case, one of the two second electrodes 32B can be used in common with one of the two second electrodes 32A. The distance between the optical waveguide 2A and the optical waveguide 2B can thus be reduced further. In this case, the width of the entirety of the optical modulator 101 can be further reduced, and the size reduction of the optical modulator 101 can be achieved.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical modulator, comprising:
an optical waveguide including a material with an electrooptic effect; and
control electrodes to control light that passes through the optical waveguide; wherein
the control electrodes include:
a first electrode;
two second electrodes to receive a voltage with an identical phase to a voltage applied to the first electrode; and
a third electrode to generate a potential difference from a group of the first electrode and the second electrodes; wherein
in a cross-sectional view perpendicular to a direction in which the optical waveguide extends, the first electrode is on a first side of the optical waveguide in a thickness direction;
in the cross-sectional view, a first one of the two second electrodes is spaced apart from the first electrode on a first side of the first electrode in a width direction of the optical waveguide, and a second one of the two second electrodes is spaced apart from the first electrode on a second side of the first electrode in the width direction of the optical waveguide; and
in the cross-sectional view, the third electrode is on a second side of the optical waveguide in the thickness direction.

2. The optical modulator according to claim 1, wherein in a cross-sectional view perpendicular to the direction in which the optical waveguide extends, a middle position of the first electrode in a width direction is at a middle portion of the optical waveguide in a width direction, and a middle position of the third electrode in a width direction is at the middle portion of the optical waveguide in the width direction.

3. The optical modulator according to claim 1, wherein in a cross-sectional view perpendicular to the direction in which the optical waveguide extends, the two second electrodes are arranged in the width direction of the optical waveguide symmetrically with respect to the first electrode.

4. The optical modulator according to claim 1, wherein
in the width direction of the optical waveguide, the first one of the second electrodes is spaced apart from an end portion of the optical waveguide on a first side, and the second one of the second electrodes is spaced apart from an end portion of the optical waveguide on a second side;
the optical modulator further comprises a low-permittivity layer with a lower permittivity than the optical waveguide; and
the low-permittivity layer at least partially covers surfaces of the second electrodes to be interposed between the second electrodes and the third electrode.

5. The optical modulator according to claim 4, wherein the low-permittivity layer at least partially covers a surface of the first electrode to be interposed between the first electrode and the third electrode.

6. The optical modulator according to claim 1, further comprising:
an auxiliary low-permittivity layer with a lower permittivity than the optical waveguide;
the auxiliary low-permittivity layer at least partially covers a surface of the third electrode to be interposed between the second electrodes and the third electrode.

7. The optical modulator according to claim 1, wherein the material of the optical waveguide is LiNbO₃.

8. The optical modulator according to claim 1, further comprising a substrate on which the optical waveguide is provided.

9. The optical modulator according to claim 8, wherein
the substrate includes an identical material to that of the optical waveguide; and
the optical waveguide is a ridge waveguide.

10. The optical modulator according to claim 1, further comprising:
two optical modulator units parallel or substantially parallel to each other, and each including the optical waveguide and the control electrodes.

11. The optical modulator according to claim 10, wherein
each of the optical modulator units further includes a substrate on which the optical waveguide is provided; and
the substrate in a first one of the two optical modulator units is parallel or substantially parallel with the substrate in a second one of the two optical modulator units.

12. The optical modulator according to claim 11, wherein in each of the optical modulator units, the substrate includes an identical material to that of the optical waveguide, and the optical waveguide is a ridge waveguide.

13. The optical modulator according to claim 11, wherein
the substrate in the first one of the two optical modulator units is integrated with the substrate in the second one of the two optical modulator units; and
the first electrode and the second electrode in the first optical modulator unit receive a voltage with an opposite phase to a voltage applied to the first electrode and the second electrode in the second optical modulator unit.

14. The optical modulator according to claim 11, wherein
the substrate in the first one of the two optical modulator units is integrated with the substrate in the second one of the two optical modulator units;
the optical waveguide in the first one of the two optical modulator units and the optical waveguide in the second one of the two optical modulator units have spontaneous polarization reversed from each other;
one of the two second electrodes in the first one of the two optical modulator units is integrated with one of the two second electrodes in the second one of the two optical modulator units; and
the first electrode and the second electrode in the first one of the two optical modulator units receive a voltage with an identical phase to a voltage applied to the first electrode and the second electrode in the second one of the two optical modulator units.

15. The optical modulator according to claim 1, wherein the material of the optical waveguide is lithium tantalate, lead lanthanum zirconate titanate, potassium tantalum niobium oxide, or barium titanate.

16. The optical modulator according to claim 1, wherein the optical waveguide includes a substrate with titanium diffused therein.

17. The optical modulator according to claim 1, wherein the optical modulator is a Mach-Zehnder optical modulator.

18. The optical modulator according to claim 1, wherein the first electrode and the second electrodes are signal electrodes.

19. The optical modulator according to claim 1, wherein the third electrode is a ground electrode.

20. The optical modulator according to claim 1, wherein the third electrode is an inverse signal electrode to receive a voltage with an opposite phase to the voltage applied to the first electrode and the second electrodes.
